(19) United States
(12) Patent Application Publication
(10) Pub. No.: US 2005/0237007 A1
(43) Pub. Date: Oct. 27, 2005

(54) ELECTRONIC ALTERNATING-CURRENT REGULATOR

(76) Inventor: Chung-Han Huang, Luzhou City (TW)

Correspondence Address: Chung-Han Huang, P.O. Box No. 6-57, Junghe, Taipei, 235, TW

(21) Appl. No.: 10/829,260

(22) Filed: Apr. 22, 2004

(51) Int. Cl. H05B 37/02

(52) U.S. Cl. 315/291; 315/224; 315/308; 315/307

(57) ABSTRACT

An electronic alternating-current regulator for supplying a high-voltage direct current for activating a discharging light tube for steady illumination comprises a power circuit, a voltage control circuit, an activation circuit and a load circuit. The voltage control circuit utilizes effects of a power factor rectification integrated circuit and a transistor to control a direct-current voltage. An over-voltage/leakage protection circuit is connected in parallel between the voltage control circuit and the activation circuit, and is for activating a PNP transistor connected between a base end of a first transistor and a bi-directional thyrator, thereby serving as a protection switch over operations of the activation circuit. Accordingly, an alternating current ranging from 95V to 265V can be applied to a power input end while over-voltage/leakage protection effects are offered.

### BACKGROUND OF THE INVENTION

(a) Field of the Invention

The invention relates to an electronic alternating-current regulator, and more particularly, to a power regulator extensive utilized for a discharging light tube that uses an alternating current ranging between 95V and 256V and having over-voltage/leakage protection effects.

(b) Description of the Prior Art

A common electronic regulator utilized for illuminating discharging light tubes using an alternating current, has a circuit at least comprising a power circuit, an activation circuit and a step-up circuit. Wherein, two high-voltage ends of the step-up circuit are connected with at least one light tube that is illuminated using controls of the regulator.

However, in such prior electronic regulator, a power circuit thereof is a simple rectification circuit or an LC-regulated rectification circuit lacking other regulating circuit, and therefore has various application restrictions for merely being capable of receiving an alternating current having a fixed voltage (110V or 220V). In addition, glittering of lights is easily produced to even lead to damages of the light tube. Also, because a prior electronic regulator is not provided with an over-voltage or light tube leakage protection circuit, not only short-circuit is often incurred but over-current is caused when there is leakage of argon from the light tube to damage the circuit and to further result in accidents. It is essential that such prior electronic regulator be advanced.

In the view of the aforesaid drawbacks of the prior alternating-current electronic regulator necessarily requiring fixed alternating-current voltage inputs and lacking over-voltage and leakage protection effects, it is a vital task of the invention as how to provide a novel electronic alternating-current regulator capable of overcoming the aforesaid drawbacks.

### SUMMARY OF THE INVENTION

The primary object of the invention is to provide an electronic alternating-current regulator having a voltage control circuit connected in series between a power circuit and an activation circuit thereof. The voltage control circuit utilizes effects of a power factor rectification integrated circuit (IC) and a transistor to control a direct current voltage, so as to be randomly connected to an alternating current ranging from 95V to 265V for application.

The second object of the invention is to provide an electronic alternating-current regulator having an over-voltage/leak protection circuit connected in parallel between an end of a voltage control circuit thereof and an activation circuit thereof, in that the over-voltage/leak protection circuit is formed by a PNP transistor (one-directional transistor) connected a base end of a first transistor of the activation circuit and a bi-directional thyrator, so as to serve as a protection switch for controlling the activation circuit.

To accomplish the aforesaid objects, the invention comprises a power circuit, a voltage control circuit, an activation circuit and a load circuit.

The power circuit is connected to an alternating current, and is consisted of an LC voltage-regulating circuit and a bridge rectification circuit, thereby transforming the alternating current into a direct current.

The voltage control circuit is connected to an output end of the bridge rectification circuit of the power circuit, and utilizes a power factor rectification integrated circuit (IC), an inductor and a transistor to control an output voltage of the direct current.

The activation circuit is connected in parallel with positive and negative ends behind the voltage control circuit, and has at least two serially connected transistors, a bi-directional thyrator connected to a base end of the first transistor and an RC circuit, so as to control the current passing through the first transistor and the second transistor.

The load circuit has at least one light tube, which has an output end of a first side thereof connected to a positive end of the voltage control circuit, and an output end of a second side connected to a node of an emitter and collector of the serially connected transistors of the activation circuit via inductors; and is connected in series to a pre-warming activation matching circuit located between an output end of the first side and an input end of the second side of the light tube.

According to the aforesaid structure, an over-voltage/leakage protection circuit is connected in parallel between the voltage control circuit and the activation circuit, and has a PNP transistor (one-directional transistor) disposed between a base end of the first transistor and the bi-directional thyrator of the activation circuit, so as to have the PNP transistor serve as a protection switch over operations of the activation circuit.

### BRIEF DESCRIPTION OF THE DRAWINGS

FIG. 1 shows a first circuit diagram of an embodiment according to the invention.

FIG. 2 shows a second circuit diagram of an embodiment according to the invention.

FIG. 3 shows a third circuit diagram of an embodiment according to the invention.

### DETAILED DESCRIPTION OF THE PREFERRED EMBODIMENTS

To better understand the characteristics and technical contents of the invention, detailed descriptions of preferred embodiments shall be given with the accompanying drawings below.

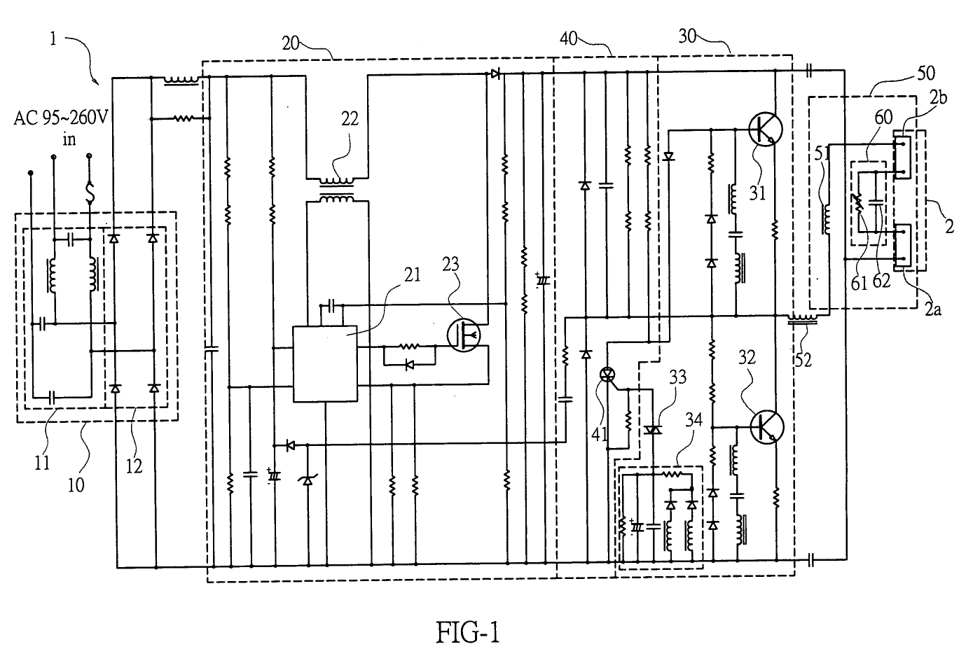

Referring to FIG. 1, an electronic regulator 1 in an embodiment according to the invention is for supplying a high-voltage direct current for activating a discharging light tube 2 for steady illumination, and comprises a power circuit 10, a voltage control circuit 20, an activation circuit 30, an over-voltage/leakage protection circuit 40 and a load circuit 50.

The power circuit 10 is connected to an alternating current, and is consisted of an LC voltage-regulating circuit 11 and a bridge rectification circuit 12, thereby transforming the alternating current into a direct current.

The voltage control circuit 20 is connected to an output end of the bridge rectification circuit 12 of the power circuit 10, and utilizes a power factor rectification integrated circuit (IC) 21, an inductor 22 and a transistor 23 to control an output voltage of the direct current.

The activation circuit 30 is connected in parallel with positive and negative ends behind the voltage control circuit 20, and has at least two serially connected transistors 31 and 32, a bi-directional thyrator 33 connected to a base end of the first transistor 31 and an RC circuit 34, so as to control the current passing through the first transistor 31 and the second transistor 32.

The over-voltage/leakage protection circuit 40 is connected in parallel between the voltage control circuit 20 and the activation circuit 30, and has a PNP transistor (one-directional transistor) 41 disposed between the first transistor 31 and the base end of the bi-directional thyrator 33 of the activation circuit 30, so as to have the PNP transistor 41 serve as a protection switch over operations of the activation circuit 40.

The load circuit 50 has a light tube 2, which has an output end of a first side 2a connected to a positive end of the voltage control circuit 20, and an output end of a second side 2b connected to a node of an emitter and collector of the serially connected transistors 31 and 32 of the activation circuit 30 via inductors 51 and 52. A pre-warming activation matching circuit 60 is connected in series between an output end of the first side 2a and an input end of the second side 2b of the light tube.

To put the aforesaid electronic regulator 1 to use, an alternating current is inputted by the power circuit 10, rectified by the LC voltage-regulating circuit 11 and the bridge rectification circuit 12 to be transformed into a direct current. A potential of the direct current outputted by the power circuit 10 is compared by first and fifth pins of the power factor rectification IC 21 of the voltage control circuit 20, with an appropriate voltage outputted at a seventh pin of the power factor rectification IC 21 to the transistor 23, so as to regulate and stabilize the voltage of the direct current outputted by the voltage control circuit 20. Accordingly, an alternating current ranging from 95V to 265V can be randomly applied to the input end of the voltage control circuit 20 without affecting power supply from the voltage control circuit 20. The direct current regulated by the voltage control circuit 20 is conducted by the two serially connected transistors 31 and 32 of the activation circuit 30 to illuminate the light tube 2 by forming a loop at the load circuit 50. As described above, a pre-warming activation matching circuit 60 is connected between the output end of the first side 2a and the input end of the second side 2b of the light tube. The pre-warming activation matching circuit 60 is consisted of a variable capacitor 61 and a capacitor 62 connected in parallel, such that the current is passed through with delay using shielding of the variable capacitor 61 and the capacitor 62 to accomplish pre-warming effects.

According to the aforesaid electronic regulator 1, using the over-voltage/leakage protection circuit 40 located between the positive end of the voltage control circuit 20 and the activation circuit 30, when encountering abnormal voltage inputs, the collector of the PNP transistor (one-directional transistor) 41 of the over-voltage/leakage protection circuit 40 becomes an off state to cut off the control current of the first transistor 31 of the activation circuit 30, thereby accomplishing effects of a protection circuit by shutting down the activation circuit 30.

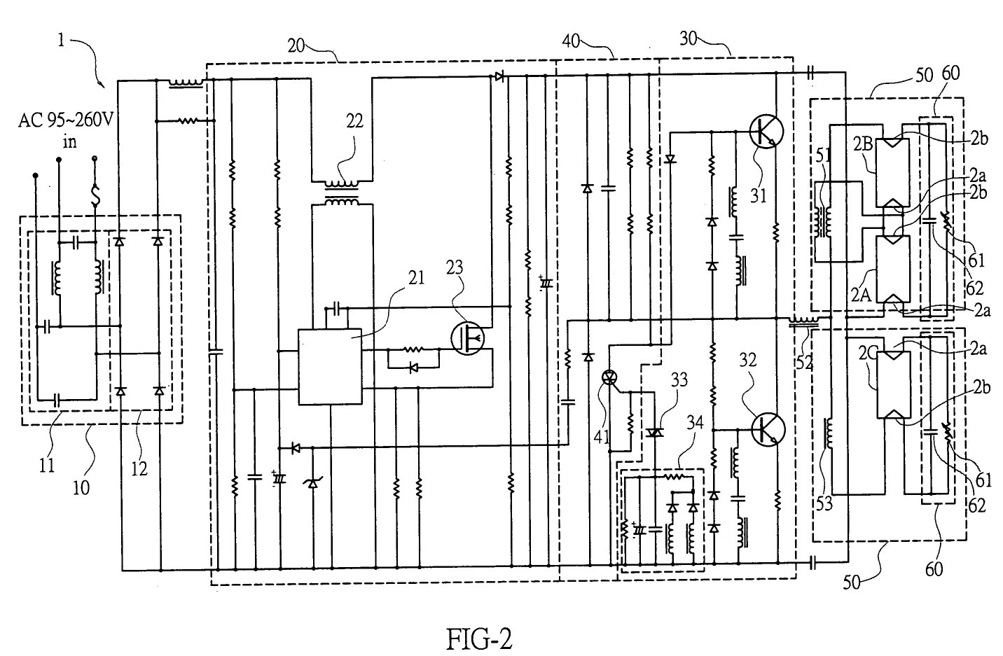

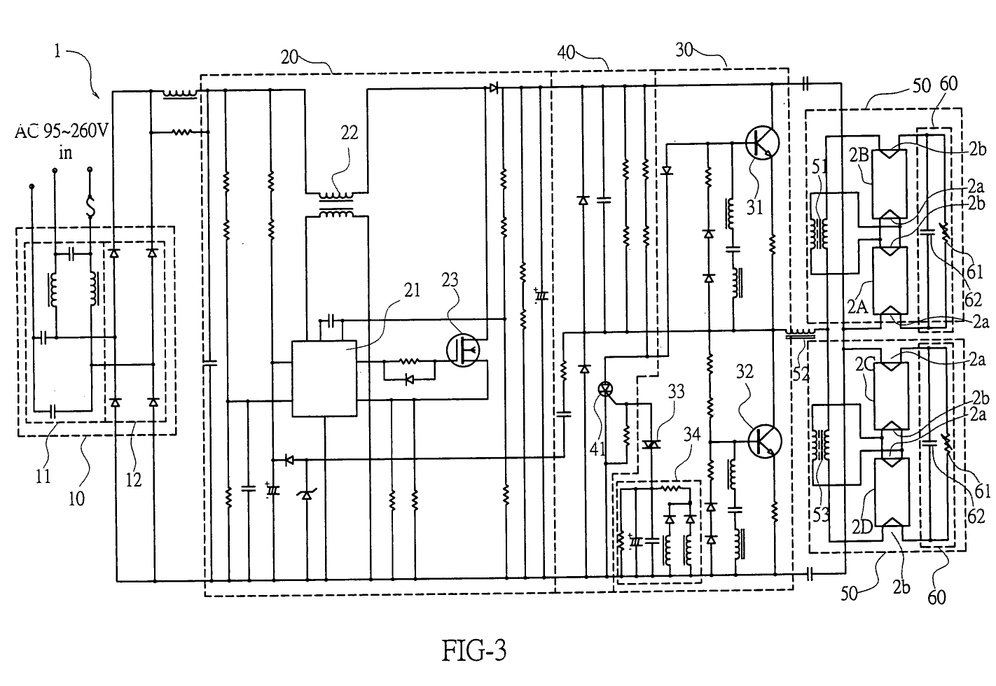

Referring to FIGS. 2 and 3 showing another embodiment, the load circuit 50 of the electronic regulator 1 shown in FIG. 1 is connected in parallel with three or four discharging light tubes at the same time. Wherein, two light tubes are connected in parallel to form a set. An input end of a first side 2a of a first light tube 2A is connected to a positive end of the voltage control circuit 20. An output end of a second side 2b of a second light tube 2B is connected to a node of an emitter and a collector of the two serially connected transistors 31 and 32 of the activation circuit 30 via the inductors 51 and 52. A pre-warming activation matching circuit 60 is connected in series between an output end of the first side 2a of the first light tube 2A and an input end of the second side 2b of the second light tube 2B. A secondary side coil of the inductor 51 is connected in parallel between the second side 2b of the first light tube and the first side 2a of the second light tube. Between a primary side coil of the inductor 51 and the other serially connected inductor 52 is an inductor 53 connected to an output end of a second side 2b of a third light tube 2C, or an inductor 53 connected to an output end of a second side of the fourth light tube 2D that is connected in parallel with the third light tube 2C. According to the aforesaid descriptions, circuits of the third light tube 32 are as those in the embodiment shown FIG. 1, and the parallel circuits of the third and fourth light tubes 2C and 2D are connected as those of the first light tube 2A and the second light tube 2B. Other light tubes can be connected similarly to put more light tubes to application at once.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An electronic alternating-current regulator for supplying a high-voltage direct current for activating a discharging light tube for steady illumination, comprising a power circuit, a voltage control circuit, an activation circuit, an over-voltage/leakage protection circuit and a load circuit; wherein:
the power circuit is connected to an alternating current, and is consisted of an LC voltage-regulating circuit and a bridge rectification circuit, thereby transforming the alternating current into a direct current;
the voltage control circuit is connected to an output end of the bridge rectification circuit of the power circuit, and utilizes a power factor rectification integrated circuit (IC), an inductor and a transistor to control an output voltage of the direct current;
the activation circuit is connected in parallel with positive and negative ends behind the voltage control circuit; and has at least two serially connected transistors, a bi-directional thyrator connected to a base of the first transistor and an RC circuit, thereby controlling the current passing through the first transistor and the second transistor;
the load circuit has at least one light tube, which has an output end of a first side thereof connected to a positive end of the voltage control circuit, and an output end of a second side connected to a node of an emitter and collector of the serially connected transistors of the activation circuit via inductors; and is connected in series to a pre-warming activation matching circuit located between an output end of the first side and an input end of the second side of the light tube.

2. The electronic alternating-current regulator in accordance with claim 1, wherein the load circuit has two light tubes to form a set; an input end of a first side of a first light tube is connected to a positive end of the voltage control circuit; an output end of a second side of a second light tube is connected to a node of an emitter and a collector of the two serially connected transistors of the activation circuit via the inductors connected in series; a pre-warming activation matching circuit is connected in series between an output end of the first side of the first light tube and an input end of the second side of the second light tube; a secondary side coil of the inductor is connected in series between the second side of the first light tube and a first side of the second light tube.

3. The electronic alternating-current regulator in accordance with claim 1, wherein the load circuit has two light tubes connected in parallel to form a set having one more light tube connected in parallel; an input end of a first side of a light tube is connected to a positive end of the voltage control circuit; an output end of a second side of a second light tube is connected to a node of an emitter and a collector of the two serially connected transistors of the activation circuit via the inductors connected in series; and a pre-warming activation matching circuit is connected in series between an output end of the first side of the first light tube and an input end of the second side of the second light tube.

4. The electronic alternating-current regulator in accordance with claim 2, wherein the load circuit has two light tubes connected in parallel to form a set connected in parallel to another set having two light tube connected in parallel; in input end of a first side of a first light tube of the latter set is connected to a positive end of the voltage control circuit; an output end of a second side of a second light tube is connected between the two inductors in series connection with an output end of a second side of the former set via an inductor; a pre-warming activation matching circuit is connected in series between an output end of a first side of the first light tube and an input end of a second side of the second light tube; and the second side of the first light tube and the first side of the second light tube are connected in series to a secondary side coil of the inductor.

5. The electronic alternating-current regulator in accordance with claim 1, wherein the pre-warming activation matching circuit is consisted of a variable capacitor and a capacitor connected is parallel, such that the current is passed through with delay using shielding of the variable capacitor and the capacitor to accomplishing pre-warming effects.

6. The electronic alternating-current regulator in accordance with claim 2, wherein the pre-warming activation matching circuit is consisted of a variable capacitor and a capacitor connected is parallel, such that the current is passed through with delay using shielding of the variable capacitor and the capacitor to accomplishing pre-warming effects.

7. The electronic alternating-current regulator in accordance with claim 3, wherein the pre-warming activation matching circuit is consisted of a variable capacitor and a capacitor connected is parallel, such that the current is passed through with delay using shielding of the variable capacitor and the capacitor to accomplishing pre-warming effects.

8. The electronic alternating-current regulator in accordance with claim 4, wherein the pre-warming activation matching circuit is consisted of a variable capacitor and a capacitor connected is parallel, such that the current is passed through with delay using shielding of the variable capacitor and the capacitor to accomplishing pre-warming effects.

9. The electronic alternating-current regulator in accordance with claim 1, wherein an over-voltage/leakage protection circuit is connected in parallel between the voltage control circuit and the activation circuit, and has a PNP transistor (one-directional transistor) disposed between the first transistor and the base end of the bi-directional thyrator of the activation circuit, thereby having the PNP transistor serve as a protection switch over operations of the activation circuit.

10. The electronic alternating-current regulator in accordance with claim 2, wherein an over-voltage/leakage protection circuit is connected in parallel between the voltage control circuit and the activation circuit, and has a PNP transistor (one-directional transistor) disposed between the first transistor and the base end of the bi-directional thyrator of the activation circuit, thereby having the PNP transistor serve as a protection switch over operations of the activation circuit.

11. The electronic alternating-current regulator in accordance with claim 3, wherein an over-voltage/leakage protection circuit is connected in parallel between the voltage control circuit and the activation circuit, and has a PNP transistor (one-directional transistor) disposed between the first transistor and the base end of the bi-directional thyrator of the activation circuit, thereby having the PNP transistor serve as a protection switch over operations of the activation circuit.

12. The electronic alternating-current regulator in accordance with claim 4, wherein an over-voltage/leakage protection circuit is connected in parallel between the voltage control circuit and the activation circuit, and has a PNP transistor (one-directional transistor) disposed between the first transistor and the base end of the bi-directional thyrator of the activation circuit, thereby having the PNP transistor serve as a protection switch over operations of the activation circuit.
